(19) United States
(12) Patent Application Publication
(10) Pub. No.: US 2025/0087194 A1
(43) Pub. Date: Mar. 13, 2025

(54) Tuned Spherical Dome Bells and Musical Instruments Including Them

(71) Applicant: PlayCore Wisconsin, Inc., Chattanooga, TN (US)

(72) Inventors: Luke Hayworth, Chattanooga, TN (US); Richard Cooke, Hesperus, CO (US)

(21) Appl. No.: 18/827,118

(22) Filed: Sep. 6, 2024

Related U.S. Application Data
(60) Provisional application No. 63/581,366, filed on Sep. 8, 2023.
(60) Provisional application No. 63/581,909, filed on Sep. 11, 2023.

(51) Int. Cl. G10K 1/26; G10K 1/072; G10K 1/10

(52) U.S. Cl. CPC G10K 1/26; G10K 1/072; G10K 1/10

(57) ABSTRACT

Musical instruments comprising tuned spherical cap bells that are individually mounted a framework to provide unique play opportunities. The spherical cap bells are tuned by controlling the height of the bell, by producing a thinned wall area that extends upward from the bottom edge, or both. The musical instruments may be configured to have a playful and recognizable appearance, such as for instance a caterpillar. The musical instruments may also be configured for installation in an outdoor environment.

### PRIORITY

The present application claims priority to U.S. Provisional Patent Application No. 63/581,366, filed on Sep. 8, 2023, and U.S. Provisional Patent Application No. 63/581,909, filed on Sep. 11, 2023, the entireties of which are hereby incorporated by reference.

### FIELD OF THE INVENTION

The present disclosure relates to tuned spherical dome bells that are configured to be struck by a mallet to product a musical sound having a defined pitch, e.g. on a musical scale, as well as the method of preparing tuned spherical dome bells and musical instruments that include one or more of the tuned spherical dome bells.

### BACKGROUND

Research has shown that musical play is a key component of development in children. Music helps to build reasoning skills and cognitive development. It can increase the capacity of one's memory, refine time management and organizational skills, and teach perseverance. Playing music builds confidence, encourages creativity and self-expression. It can reduce anxiety, relieve symptoms of depression, and elevate one's mood. The Brain and Creativity Institute found that musical experiences in childhood can accelerate brain development, particularly in the areas of language acquisition and reading skills.

Research has also shown that being outside enhances a child's development. Nature is important to children's development in every major way—intellectually, emotionally, socially, spiritually and physically. Kellert, Stephen R., “Nature and Childhood Development”, In Building for Life: Designing and Understanding the Human-Nature Connection, Island Press, 2005. “Experience of the outdoors has the potential to confer a multitude of benefits on young people's physical development, emotional and mental health and well-being and societal development. Mental health and wellbeing benefits from play in natural settings appear to be long-term, realized in the form of emotional stability in young adulthood.” Travlou, Penny, “Wild Adventure Space For Young People”, OPENspace Individual Literature Reviews (2006).

As such, instruments placed in outdoor learning environments enable “children to explore natural sounds in the environment, make loud music, compose music individually and collaboratively, and move expressively.” Spencer, Karin H, et al., Quality Outdoor Play Spaces for Young Children, Young Children, pp 28-34 (2014).

The use of hemispherical bells in outdoor musical instruments is known in the art, as seen, for example, in a musical instrument known as the “Pagoda Bells,” which is shown in FIG. 1. These bells, however, are not tuned. To the best of the inventor's knowledge, no one has yet determined how to tune a hemispherical bell, which in contrast to bells of other shapes (those having conventional “bell” shapes, conical bells, etc.) involve added complexities when it comes to tuning. Moreover, while the “Pagoda Bells” continue to offer a fun play opportunity, it is desired to have musical instruments that provide different and unique play opportunities.

### SUMMARY OF THE INVENTION

Embodiments of the present disclosure are directed to a tuned spherical dome bell and to a method of preparing a tuned spherical dome bell, which may also be referred to as a spherical cap bell. Spherical dome bells include but are not limited to hemispherical bells, which is a spherical domed bell in which the plane that passes through the sphere passes through the center of the sphere so that the height of the spherical domed bell is equal to the radius. Spherical dome bells also include bells in which the plane that passes through the sphere passes through the sphere at a position other than the center of the sphere, such that the height of the spherical dome bell is less than the radius of the spherical dome bell.

Some embodiments of the present disclosure are directed to a spherical dome bell having a thinned inner wall region extending upward a defined distance from a bottom edge. A depth of the thinned inner wall region, a height of the thinned inner wall region, or both may be selected so that the bell is tuned, i.e. produces a note on a musical scale when struck by a mallet. In some embodiments, for instance, a height of the thinned inner wall region may be between 5% and 60% of a height of the bell, a thickness of the thinned inner wall region may be between about 70% and about 95% of the thickness of an un-thinned inner wall region, or both.

As explained above, in some embodiments, the height of the bell may not be equivalent to the radius of the bell. Rather, in some embodiments, the tuned spherical dome bell may have a height that is less than the radius defined by a bottom edge of the bell. In some embodiments, for instance, the height of the bell may be between about 60% and 99% of the radius defined by a bottom edge of the bell. In some embodiments, tuning of the bell may be achieved by careful control over the height of the bell, and more particularly the relationship between the height of the bell and the radius of the bell, and may not require any thinning of the inner wall.

In some embodiments, the tuned spherical dome bell may produce a note that is at least 85% accurate (as measured by a tuner), more preferably at least 90% accurate, more preferably at least 95% accurate, more preferably at least 98% accurate, more preferably at least 99% accurate when struck by a mallet.

In some embodiments, and particularly for instance where the bell is configured for outdoor use, the tuned spherical dome bell may be made of aluminum or an aluminum alloy, and may be anodized.

Embodiments of the present invention are also directed to musical instruments, and in particular musical instruments configured for mounting in an outdoor environment such as a playground or other public recreational area, that include a plurality of spherical dome bells, and more particularly a plurality a spherical dome bells that have been tuned as described herein. These musical instruments may be configured so that each spherical dome bell is independently supported by a mounting bar, e.g. each bell being supported by a corresponding finger of a mounting bar, such that the spherical dome bells can be arranged side-by-side, e.g. in a linear or curvilinear arrangement.

In some embodiments, these musical instruments may be configured to have the appearance of a plant or animal that might be found in nature. As shown in the illustrated embodiment, for instance, the musical instrument may be configured to have the appearance of a caterpillar. By providing musical instruments having such unique but familiar appearances, it is believed that the enjoyment level of the musical instrument to children is increased.

In some embodiments, the musical instrument may include a plurality of spherical dome bells, such as the tuned spherical dome bells described herein, and a frame configured to individually support the plurality of spherical dome bells above a surface, such as an outdoor surface, to which the frame is mounted. The frame may include a support post having a top end and a bottom end, the bottom end being configured to be mounted to a surface, such as an outdoor surface, and a mounting bar attached to the top end of the support post. The mounting bar may extend substantially parallel with the surface to which the support post is mounted. The musical instrument may also comprise a plurality of fingers that extend upward from the mounting bar, each of the fingers being configured to support one of the plurality of spherical dome bells such that a bottom edge of the bell is elevated above the mounting bar.

In some embodiments, the mounting bar may be linear or curvilinear. In such embodiments, the fingers may be aligned in a linear or curvilinear manner and the plurality of spherical dome bells may be aligned in a linear or curvilinear arrangement. In some embodiments, the mounting bar may be linear, the fingers may be aligned in a linear manner, and the plurality of spherical dome bells may be aligned in a linear manner. In other embodiments, the mounting bar may be curvilinear, the fingers may be aligned in a curvilinear manner, and the plurality of spherical dome bells may be aligned in a curvilinear manner.

The musical instrument may also include one or more, and desirably a plurality of, mallets by which one or more users may strike the plurality of spherical dome bells to produce a variety of notes. Each of the mallets may be attached to the support post or the mounting bar (including for instance through another element that is attached to the support post, the mounting bar, or both) by a cable in order to ensure that the mallet remains with the instrument. In some embodiments, the musical instrument may include at least first and second mallets, each of which is attached to the support post or the mounting bar by a cable. In some embodiments, the musical instrument may also include at least third and fourth mallets, each of which is attached to the support post or the mounting bar by a cable.

The musical instrument may also include one or more, and desirably a plurality of, mallet holders, each of which is configured to retain one of the one or more mallets when not in use. In some embodiments, for instance, the musical instrument may include first and second mallet holders that are configured to retain the first and second mallets when not in use. Where the musical instrument includes third and fourth mallets, the musical instrument may further include third and fourth mallet holders that are configured to retain the third and fourth mallets when not in use. Each mallet holder may comprise a cushion element that serves the dual purpose of providing a friction-fit for the mallet and preventing damage to the handle of the mallet from repeated insertion and removal.

In some embodiments, each of the mallet holders may be positioned on the mounting bar, for instance on a plate that extends from the side of the mounting bar. A non-metal cushion element may extend over at least a portion of the plate so as to surround the first and second mallet holders. The first and second mallet holders may be positioned at a first end of the mounting bar. Where the musical instrument includes third and fourth mallets, the musical instrument may further include third and fourth mallet holders that may be positioned at a second end of the mounting bar.

In some embodiments, for example, a first plate extends from the sides of the mounting bar at its first end and a second plate (which may be substantially identical to the first plate) extends from the sides of the mounting bar at its second end. The first plate may include first and second mallet holders for retaining the first and second mallets, e.g. with the first and second mallet holders being positioned on opposing sides of the mounting bar. Similarly, the second plate may include third and fourth mallet holders for retaining the third and fourth mallets, e.g. with the third and fourth mallet holders being positioned on opposing sides of the mounting bar. When the instrument is configured to have the appearance of a caterpillar, for example, the first and second mallets may thus serve to appear as antennae. In other embodiments, it is contemplated that the mallets may serve to appear as appendages, including but not limited to legs and/or arms.

The spherical dome bells may be mounted to the fingers in a variety of manners, so long as the mounting arrangement does not unduly interfere with resonance of the note produced by the bell when struck with a mallet. To ensure better resonance, each of the plurality of spherical dome bells may be spaced from the finger that supports it by a non-metal spacer. In some embodiments, for instance, each of the plurality of spherical dome bells may be attached to the finger that supports it by a threaded fastener that passes through elements that include, in order, (i) an aperture at the top center of the spherical dome bell, (ii) a non-metal spacer, and (iii) at least a portion of a central aperture of the finger. The internal surface of the finger that defines the central aperture may itself be threaded, thereby allowing for easy mounting of each spherical dome bell.

The musical instrument, and more particularly the bottom end of the support post, may be mounted to a surface, such as an outdoor surface, in any of a variety of manners. In some embodiments, for instance, the bottom end of the support post may be mounted to an outdoor surface by the base plate being attached to one of (a) an in-ground post, e.g. where the support post is mounted to a natural earth surface; (b) an outdoor surface, e.g. where the support post is mounted to an artificial surface such as concrete, concrete that is covered with poured-in-place rubber, or the like; or (c) an outdoor stand, e.g. where it is desired that the musical instrument is not permanently installed but rather can be transported between locations.

In some embodiments, the musical instrument may be configured to suspend the spherical domed bells from a frame that extends vertically above each of the bells. The frame may include a support post having a top end and a bottom end, the bottom end being configured to be mounted to a surface, such as an outdoor surface, and a mounting bar attached to the top end of the support post. The mounting bar may extend substantially parallel with the surface to which the support post is mounted, or as in the illustrated embodiment may extend at an acute angle with the surface to which the support post is mounted. Moreover, the support post may be connected with the mounting bar in a manner that provides the appearance of a single, integral piped frame element or the support post and the mounting bar may be integral with one another to produce a single, integral piped frame. In the illustrated embodiment, for example, a single piped frame includes a support post having a top end that curves directly into a mounting bar.

The musical instrument may also comprise a plurality of fingers that extend downward from the mounting bar, each of the fingers being configured to support one of the plurality of spherical dome bells such that a top edge of the bell is supported and suspended below the mounting bar.

In some embodiments, the mounting bar may be linear or curvilinear. In such embodiments, the fingers may be aligned in a linear or curvilinear manner and the plurality of spherical dome bells may be aligned in a linear or curvilinear arrangement. In some embodiments, the mounting bar may be linear, the fingers may be aligned in a linear manner, and the plurality of spherical dome bells may be aligned in a linear manner. In other embodiments, the mounting bar may be curvilinear, the fingers may be aligned in a curvilinear manner, and the plurality of spherical dome bells may be aligned in a curvilinear manner. In some embodiments, including the illustrated embodiment, where the spherical dome bells are tuned and where the mounting bar forms an acute angle with the ground surface, the tuned spherical dome bells may be aligned in order of bells that produce high notes being positioned at a greater height from the ground surface and moving downward to the bells that produce low notes being positioned closer to the ground surface.

The musical instrument may also include one or more, and desirably a plurality of, mallets by which one or more users may strike the plurality of spherical dome bells to produce a variety of notes. Each of the mallets may be attached to the support post or the mounting bar (including for instance through another element that is attached to the support post, the mounting bar, or both) by a cable in order to ensure that the mallet remains with the instrument. In some embodiments, the musical instrument may include at least first and second mallets, each of which is attached to the support post or the mounting bar by a cable. The musical instrument may include mallet holders or, given the height of the bells, the mallets may simply be suspended above the ground surface by the cables.

Each spherical dome bell may be mounted to one of the fingers in a variety of manners, so long as the mounting arrangement does not unduly interfere with resonance of the note produced by the bell when struck with a mallet. To ensure better resonance, each of the plurality of spherical dome bells may be spaced from the bottom surface of the finger that supports it by a non-metal spacer. In some embodiments, for instance, each of the plurality of spherical dome bells may be attached to the finger that supports it by a threaded fastener that passes through elements that include, in order (starting at the bottom and moving upward), (i) a non-metal washer, (ii) an aperture at the top center of the spherical dome bell, (iii) a non-metal spacer, such as a washer having a non-metal bell contact surface, and (iv) at least a portion of a central aperture of the finger. The internal surface of the finger that defines the central aperture may itself be threaded, thereby allowing for easy mounting of each spherical dome bell.

The musical instrument, and more particularly the bottom end of the support post, may be mounted to a surface, such as an outdoor surface, in any of a variety of manners. In some embodiments, for instance, the bottom end of the support post may be mounted to an outdoor surface by the base plate being attached to one of (a) an in-ground post, e.g. where the support post is mounted to a natural earth surface; (b) an outdoor surface, e.g. where the support post is mounted to an artificial surface such as concrete, concrete that is covered with poured-in-place rubber, or the like; or (c) an outdoor stand, e.g. where it is desired that the musical instrument is not permanently installed but rather can be transported between locations.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is perspective view of a prior art “Pagoda Bells” product.

FIG. 2 is a perspective view of a musical instrument according to a first embodiment of the present disclosure, showing a mounting arrangement in which a bottom plate is attached directly to an outdoor surface.

FIG. 3 is a perspective view of the musical instrument of FIG. 2, showing a mounting arrangement in which a bottom plate is attached to a movable stand.

FIG. 4 is a side elevation view of the musical instrument of FIG. 2, showing a mounting arrangement in which a bottom plate is attached to an in-ground post.

FIG. 5 is an exploded side elevation view of the musical instrument of FIG. 2.

FIG. 6 is a perspective view of the frame for the musical instrument of FIG. 2.

FIG. 7 is a top perspective view of the musical instrument of FIG. 2, showing the attachment of a cushioned mallet holder to the frame.

FIG. 8 is a perspective view, in cross-section, of a first tuned hemispherical bell in accordance with an embodiment of the present disclosure.

FIG. 9 is a side elevation view, in cross-section, of a second tuned hemispherical bell in accordance with an embodiment of the present disclosure.

FIG. 10 is a perspective view of a musical instrument according to a second embodiment of the present disclosure.

FIG. 11 is a side elevation view of the musical instrument of FIG. 10.

### DETAILED DESCRIPTION

Embodiments of the present disclosure are directed to musical instruments, and in particular musical instruments configured for installation and use in an outdoor environment, that utilize spherical dome bells. One such embodiment is shown in FIGS. 2-7. The musical instrument 100 illustrated in FIGS. 2-7 includes a plurality of spherical dome bells 10, a mounting bar 20 to which each of the bells is mounted, and a support post 30 that positioned the mounting bar (and hence the plurality of bells) at a desired height above a ground surface on which the musical instrument is placed, or more typically to which the musical instrument is installed. The musical instrument also comprises a plurality of mallets 40, each of which is connected to the mounting bar 20 or the support post 30 by a cable, and mallet holders 50 that are configured to releasably retain the mallets when not in use.

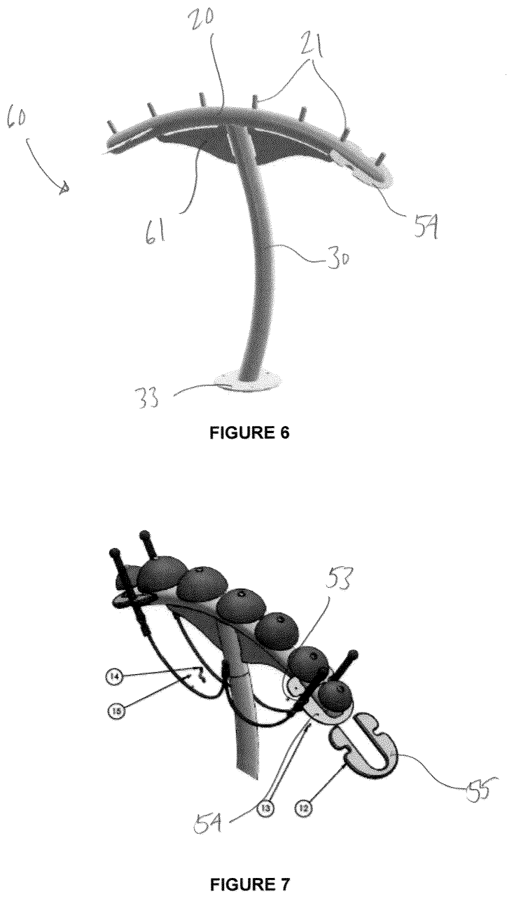

Together, the mounting bar 20 and the support post 30 define a framework 60. This framework 60 is illustrated in FIG. 6. As can best be seen in FIG. 6, the mounting bar 20 comprises a plurality of fingers 21 that extend upward. Each finger 21 is configured to support one of the plurality of spherical domed bells. In the illustrated embodiment, for instance, each finger 21 may have a central aperture and desirably a central aperture that is, at least in part, threaded, e.g. by having a coupling nut built or installed therein. In such an embodiment, a spherical domed bell 10 may be secured to a finger 21 by a threaded fastener 71 that passes through an aperture in the top of the spherical domed bell 10 and into the central aperture of the finger 21. In alternative (non-illustrated) embodiments, the fastener may pass through the finger 21 and extend out of the bottom of the mounting bar 20, whereby a nut or the like could be used to secure the fastener in place.

As shown in FIG. 5, the fastener 71 may also pass through one or more additional components. For instance, in order to provide an improved sound quality and a longer-resonating sound when the spherical domed bell 10 is struck with a mallet 40, interference between the top surface of the metal finger 21 and the underside of the spherical domed bell 10 may be reduced. This may be accomplished by the provision of one or more non-metal spacers 72 between the spherical domed bell and the top of the finger. In such case, the fastener 71 may also pass through the one or more non-metal spacers 72. The one or more spacers 72 may be made of any of a variety of materials, including for example nylon. Similarly, in order to provide an improved sound and sustain, a non-metal washer 73 may also be provided between the upper surface of the spherical domed bell 10 and the head of the fastener 71. The non-metal washer 73 may be made of any of a variety of materials, including for example natural or synthetic rubber. In some embodiments, for instance, the non-metal washer 73 may be made of neoprene.

Accordingly, in some embodiments, and as is shown in FIG. 5, the spherical domed bell 10 may be mounted to the finger by a threaded fastener 71 that passes, in descending order, through at least the following components: (i) a non-metal washer 73, (ii) a central aperture of the spherical domed bell 10, (iii) an aperture of a non-metal spacer 72, and into (iv) a coupling nut positioned within the finger 21. By having each spherical domed bell 10 by individually supported by a finger 21 of the framework 60, a variety of unique musical instruments 100 can be envisioned simply by providing frameworks 60 having different arrangements of fingers.

In the illustrated embodiment, the framework 60 comprises a curvilinear mounting bar 20 in which the fingers 21, and hence the plurality of spherical domed bells 10, are arranged in a curvilinear row between a first end 22 and a second end 23. In other (non-illustrated) embodiments, the mounting bar 20 may be linear rather than curvilinear, and the fingers 21 and spherical domed bells 10 may be arranged in a linear row between a first end and a second end. In yet other alternative embodiments, the framework 60 may include multiple mounting bars 20 and/or a mounting bar having a complex shape, such that the fingers 21, and thus the spherical domed bells 10, may be arranged in any of a variety of configurations to produce a musical instrument having a unique shape and/or offering a unique play opportunity.

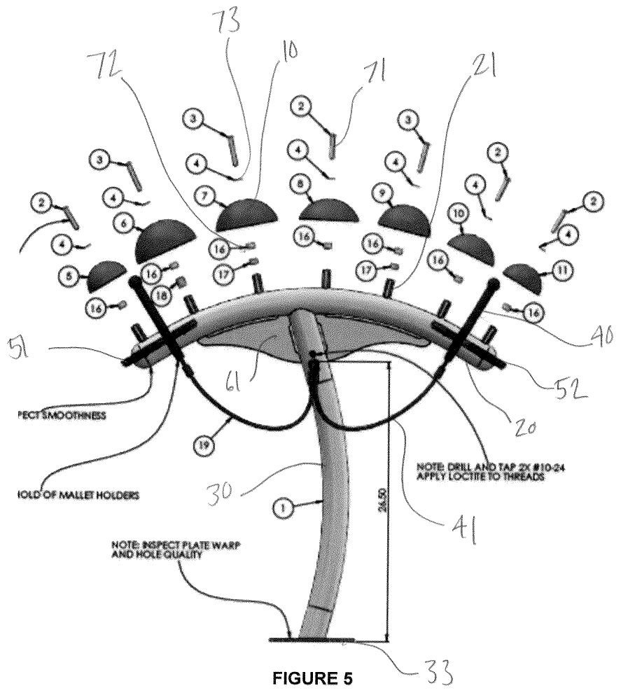

In the illustrated embodiment, the mounting bar 20 is substantially parallel with the ground surface 200 on which the musical instrument is supported (and in some embodiments installed), as can best be seen for example in FIG. 4. For purposes of determining whether the mounting bar 20 is substantially parallel, the curvature of the bar can be ignored. Thus, because the mounting bar 20 of the illustrated embodiment spans between a first end 22 and a second end 23 and because the first and second ends are located at generally the same height (such that a plane defined by the two ends is generally parallel with the ground surface 200), the mounting bar 20 of the illustrated embodiment is considered substantially parallel with the ground surface. In other, non-illustrated embodiments, the mounting bar 20 may not be substantially parallel with the ground surface; indeed any of a variety of orientations may be utilized to create a unique shape and/or provide a unique play opportunity.

By having the mounting bar 20 be substantially parallel with the ground surface 200 and the fingers 21 extending generally upward from the mounting bar, the plurality of spherical domed bells 10 can be mounted with the free edge of each bell facing generally downward, thereby ensuring that the entirety of the outer surface of each bell is exposed and oriented for easy striking with a mallet. In other, non-illustrated embodiments, however, the mounting bar 20 may comprise fingers 21 that extend in directions other than upward. In some embodiments, for instance, one or more fingers 21 may extend from a side of the mounting bar, in which case one or more of the spherical domed bells 10 may be oriented sideways. While this may make part of the outer surface of the bell 10, e.g. the part facing the ground surface 200, more difficult to strike, such a mounting arrangement could help produce a musical instrument having a unique shape and/or offering a unique play opportunity. Similarly, it is contemplated that downward-extending fingers 21 could be included in some embodiments to produce unique shapes and/or play opportunities.

The mounting bar 20 may be made from any of a variety of materials, so long as it has the necessary strength and weather resistance to stand up to prolonged outdoor environmental exposure and use. In some embodiments, the mounting bar 20 may comprise powder-coated steel pipe. The powder coating serves to protect the steel against corrosion and other environmental degradation. The powder coating can also provide the mounting bar 20 with any of a variety of colors. As an alternative to powder coating, the steel pipe may be galvanized.

The mounting bar 20 is supported at an elevation above the ground surface 200 by one or more support posts 30. In the illustrated embodiment, a single support post 30 is utilized, though multiple support posts could easily be used without departing from the scope of the present disclosure. The support post 30 extends substantially vertically between a bottom end 31 and a top end 32. In order to provide the musical instrument with a unique shape, the support post 30 may have one or more areas of curvature between the bottom and top ends, e.g. as can best be seen in FIG. 4, though a straight support post can be used as well.

The support post 30 may be made from any of a variety of materials, so long as the support post has the necessary strength and weather resistance to stand up to prolonged outdoor environmental exposure and use. In some embodiments, the support post 30 may comprise powder-coated steel pipe. The powder coating serves to protect the steel against corrosion and other environmental degradation. The powder coating can also provide the support post 30 with any of a variety of colors. As an alternative to powder coating, the steel pipe may be galvanized.

As shown in the illustrated embodiment, the mounting bar 20 may be attached to the top end 32 of the support post 30. This may be achieved through any manner as would be understood by those skilled in the art, including for instance welding, the use of one or more fasteners, or the like. Moreover, in some embodiments, the mounting bar 20 and the support post 30 may be a single, integral component.

The bottom end 31 of the support post 30 may be configured to be mounted to an outdoor surface 200. As in the illustrated embodiment, for instance, the bottom end 31 of the support post 30 may comprise a base plate 33. The base plate 33 may have a larger radial dimension than the support post 30 itself and may be configured to be mounted to an outdoor ground surface 200 in any of a variety of ways. In some embodiments, the base plate 33 may comprise one or more, and preferably a plurality, of apertures 34, each of which is configured to receive one or more fasteners 81. The one or more fasteners 81 may comprise any conventional fasteners, including for example, screws, bolts, nuts, expansion anchors, and the like.

In some embodiments, as illustrated in FIG. 2 for example, the base plate 33 may be mounted directly to an outdoor surface 200. For instance, the one or more fasteners 81 may pass through the one or more apertures 34 in base plate 33 and directly into a ground surface, such as a concrete or other artificial surface material. In some embodiments, including that illustrated in FIG. 2, the one or more fasteners 81 may comprise one or more concrete (e.g. expansion) anchors, concrete screws, or the like. When mounted in this manner, the musical instrument 100 may be considered installed in an outdoor environment.

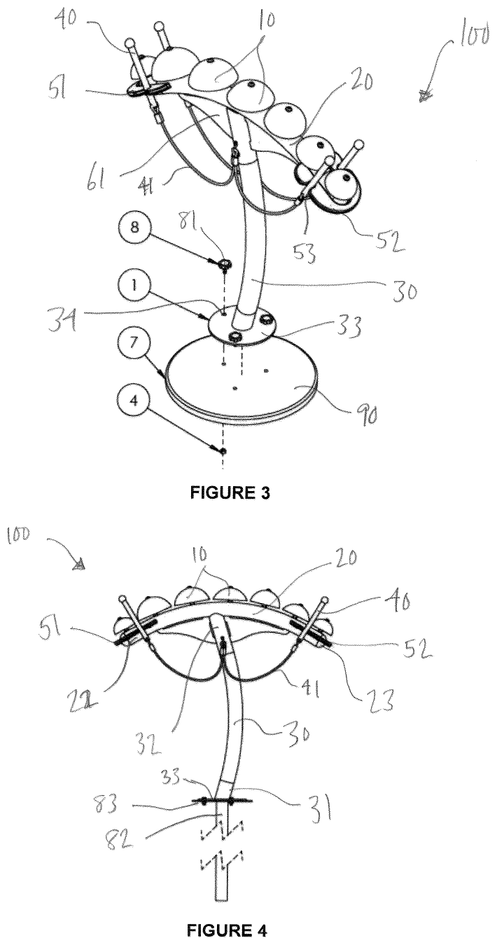

In some embodiments, the musical instrument 100 may comprise a portable stand 90 such as that illustrated in FIG. 3. The portable stand 90 has a larger radius than the base plate 33 so as to prevent tipping of the musical instrument 10. The portable stand 90 is also configured to withstand prolonged exposure to the outdoor environment. In some embodiments, the portable stand 90 may comprise one or more, and preferably a plurality, of apertures configured to receive one or more fasteners 81, by which the base plate 33 of the support post 30 and the portable stand 90 may be secured. In some embodiments, including that illustrated in FIG. 3, the one or more fasteners 81 may comprise one or more thumb screws.

In some embodiments, the musical instrument 100 may comprise an in-ground post 82, such as that illustrated in FIG. 4. The in-ground post 82 may comprise an upper plate 83 having one or more, and preferably a plurality, of apertures configured to receive the one or more fasteners 81, by which the base plate 33 of the support post 30 and the upper plate 83 of in-ground post 82 may be secured. The in-ground post 82 may be positioned in the earth under a ground surface and serve to securely and stably mount the musical instrument 100 to the ground surface. When mounted in this manner, the musical instrument 100 may be considered installed in an outdoor environment.

By providing a base plate 33 having one or more, and preferably a plurality, or apertures 34, embodiments of the musical instrument 100 disclosed herein may be mounted in an outdoor environment in any of the above-described manners.

The musical instrument 100 also includes one or more mallets 40, each of which is configured for striking one or more of the plurality of spherical domed bells 10. In order to promote social play, the musical instrument 100 may desirably include a plurality of mallets 40. Each of the one or more, and desirably plurality of, mallets 40 may be connected to the support post 30 or the mounting bar 20 by a cable 41. The term cable 41, as used herein, is intended to comprise any flexible element by which a mallet 40 may be suspended and yet allows a user to grab the mallet and use the mallet to strike the outer surface of at least one of the plurality of spherical domed bells 10, and includes for example chains, ropes, cords, and the like.

In the illustrated embodiment, each of a plurality of mallets 40 is connected to the support post 30 via a cable 41. In alternative embodiments, however, one or more of the plurality of mallets 40 may be mounted to the mounting bar 20. Additionally, in some embodiments, the framework 60 may further comprise one or more plates, such as stabilizing plates 61 shown in the illustrated embodiment, that extend from the support post 30 and/or the mounting bar 20, and at least one of the one or more mallets may be connected to one of the plates. For purposes of the present disclosure, a mallet 40 connected to a plate in this manner may still be considered connected (albeit indirectly) to the support post 30 and/or mounting bar 20 from which the plate extends.

In the illustrated embodiment, the musical instrument 100 includes a set of first and second mallets and a set of third and fourth mallets. One of the set of first and second mallets is connected to a first side of the support post 30 and the other is connected to a second, opposing side of the support post. Similarly, one of the set of third and fourth mallets is connected to a first side of the support post 30 and the other is connected to the second, opposing side. The set of first and second mallets 40 are shown extending toward the first end 22 of the mounting bar 20 and the set of third and fourth mallets are shown extending toward the second end 23 of the mounting bar.

The musical instrument 100 may also include one or more mallet holders 50. Each mallet holder 50 comprises one or more openings 53, each of which is configured to releasably receive one of the mallets 40 and to retain that mallet in place when not in use. Each of the one or more openings 53 may be fully enclosed, i.e. bordered around its entire periphery such that a user must place the handle of the mallet downward into the opening, or as in the illustrated embodiment may have a free edge by which a mallet may be inserted and removed. In some embodiments, including that illustrated, each of the one or more openings 53 may be configured to hold a mallet 40 at a position on the handle such that 50% or more of the length of the mallet is positioned above the opening. This can be achieved by sizing the opening 53 so that it provides a friction grip on the handle of the mallet once the handle is inserted into the opening (e.g. through the free edge of the opening), by providing a mallet 40 having a tapered handle (e.g. a handle with a tapered diameter), or both. Ideally, the one or more mallet holders 50 has at least the same number of mallet-retaining openings as there are connected mallets 40.

In the illustrated embodiment, the musical instrument 100 comprises a first mallet holder 51 positioned at the first end 22 of the mounting bar 20 and a second mallet holder 52 positioned at the second end 23 of the mounting bar. The first mallet holder 51 comprises openings 53 for retaining the set of first and second mallets 40 and the second mallet holder 52 comprises openings for retaining the set of third and fourth mallets. More particularly, the first mallet holder 51 has a first opening 53 positioned on a first side of the mounting bar 20 and a second opening positioned on a second, opposing side of the mounting bar. In this manner, and as can be seen in the Figures, the set of first and second mallets, when retained by the first mallet holder 51, extend upward on both sides of the mounting bar 20, thereby providing the visual appearance of a caterpillar's antennae. Similarly, the second mallet holder 52 has a first opening 53 positioned on a first side of the mounting bar 20 and a second opening positioned on a second, opposing side of the mounting bar.

As can best be seen in FIG. 7, moreover, in the illustrated embodiment, each of the first and second mallet holders 51 comprises a metal plate 54 that extends from the mounting bar 20 and a non-metal cushioning element 55 that receives and at least partially covers and/or partially surrounds the plate 54. The plate 54 may be attached to the mounting bar 20 by conventional means as would be understood by persons of skill in the art, including for example by welding, one or more fasteners, or the like. Similarly, the non-metal cushioning element 55 may be secured on the plate 54 by conventional means as would be understood by persons of skill in the art, including for instance by one or more fasteners, adhesive, friction fit, or the like. Both the plate 54 and the cushioning element 55 comprise through-holes that together form openings 53. In this manner, the openings 53 are provided with both a structural element from the plate 54 and a soft surface for the mallets from the non-metal element 55. In addition to those shown in the illustrated embodiment, it is noted that other types of mallet holders 50 and openings 53 are contemplated without departing from the scope of the present disclosure.

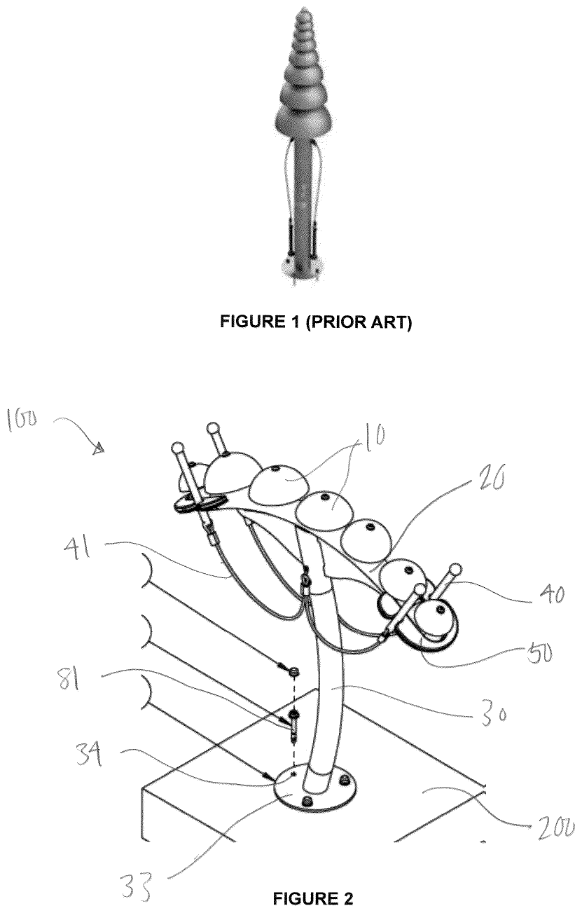

As can be seen in FIGS. 1-7, the musical instrument 100 of the illustrated embodiment has the recognizable visual appearance of a caterpillar, with the mounting bar 20, the mallet holders 50, and the spherical dome bells 10 forming the body and head and the first and second mallets 40 forming antennae. It is also contemplated that alternative, non-illustrated embodiments of musical instruments 100 having different playful visual appearances can be prepared using the present disclosure.

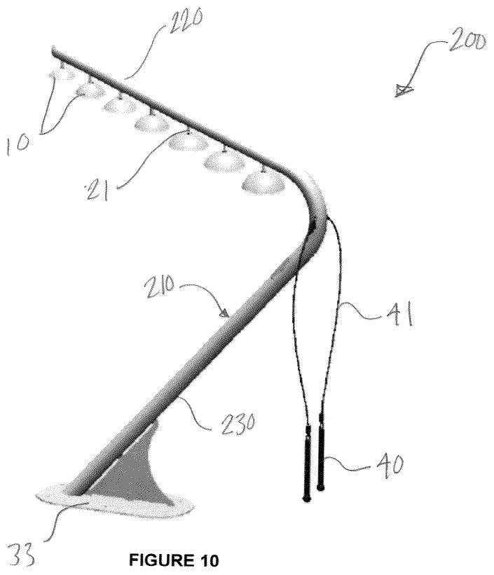

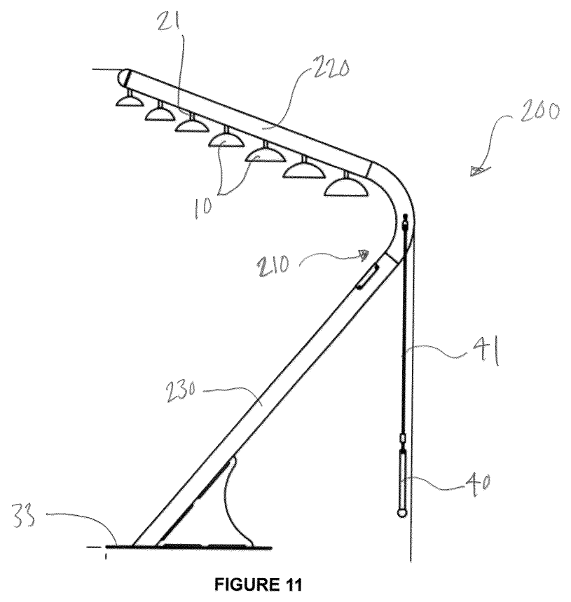

A second embodiment of a musical instrument 200 according to the present disclosure is illustrated in FIGS. 10-11. In contrast to the first embodiment, in this embodiment, each of the spherical dome bells 10 is attached to a finger 21 that extends downward from a mounting bar rather than upward. The embodiment illustrated in FIGS. 10-11 comprises a support post 230, also referred to as a support post portion of piped frame 210, and a mounting bar 220, also referred to as a mounting bar portion of the piped frame.

As shown in the illustrated embodiment, the support bar portion 230 may in some embodiments curve directly into the mounting bar portion 220, thereby providing a piped frame 210 that has a streamlined visual appearance. In the illustrated embodiment, the mounting bar portion 220 forms an acute angle with the ground surface; however in other (non-illustrated) embodiments, the mounting bar portion 220 may be parallel or substantially parallel with the ground surface. Similarly, in the illustrated embodiment, the support post portion 230 is angled with respect to the ground surface; however in other (non-illustrated) embodiments, the support post portion may be perpendicular or substantially perpendicular to the ground surface.

In the illustrated embodiment, the support post portion 230 extends in a first, or rearward, direction and the mounting bar portion 220 extends in a second opposing, or forward, direction. The combination of that orientation and of the angles produced between (i) the support post portion 230 and the ground surface and (ii) the support post portion and the mounting bar portion 220, is that the embodiment illustrated in FIGS. 10-11 has a visual appearance that mimics that of a harp.

The piped frame 210 of this embodiment may be mounted to a ground surface in any of the same manners as the first embodiment. As shown in FIG. 10, for instance, the lower end of the support post portion 230 may comprise a base plate 33 that operates in the manner described previously.

Each of the spherical dome bells 10 may also be mounted to one of the fingers 21 in a similar manner as described with respect to the first embodiment, with the primary difference being that each of the fingers extends downward and thus that the outer curved surface is adjacent to the end of the finger rather than the inner surface of the bell (i.e. the underside of the bell). As such, a threaded fastener may pass upward through the central aperture of the bell and into a central aperture of the finger rather than downward through the central aperture of the bell and into the central aperture of the finger. Similar non-metal spacing elements may be used to protect the sound quality and resonance of the bell 10. In some embodiments, for instance, a non-metal belt washer may be positioned between the inner surface of the bell and the end of the fastener; a non-metal spacer (which may include a metal washer that has a rubber or other non-metal surface that contacts the bell) may be positioned between the end of the finger and the outer surface of the bell; or most desirably both.

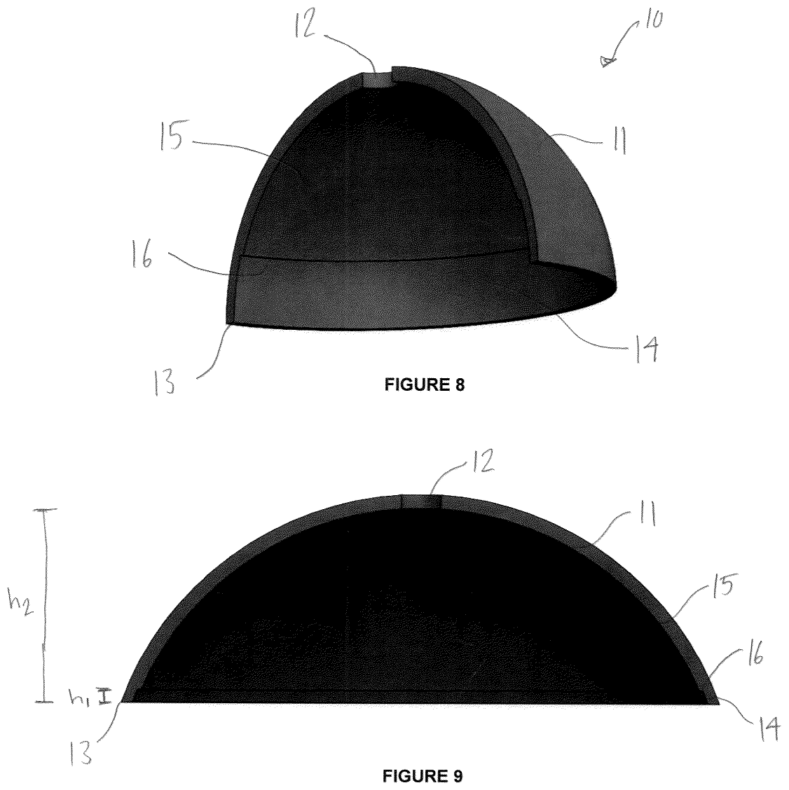

Turning to the spherical dome bells 10, also known as spherical cap bells, themselves, the spherical dome bells 10 have the shape of a sphere that has been intersected by a plane and one of the resulting two portions removed. The plane may intersect the sphere at its center, in which case the height of the spherical dome bell 10 and the radius of the spherical dome bell will be equivalent. An example of this type of spherical dome bell 10 is shown in FIG. 8. Alternatively, the plane may intersect the sphere at a position other than the center, in which case the spherical dome bell 10 has a height that is less than the radius. An example of this type of spherical dome bell 10 is shown in FIG. 9.

Each spherical dome bell 10 comprises a continuously curved wall 11 having an outer surface that is struck by a mallet 40 to produce a resonating sound and a central aperture 12 that is used to mount the bell to a framework 60 such as that described herein for example. The wall of the spherical dome bell 10 curves continuously from the central aperture 12 to a free edge 13 that is located opposite the central aperture 12, also referred to as a bottom edge.

In some embodiments, the spherical dome bells 10 may be tuned. Each bell 10 may be tuned to produce a distinct musical note when struck by a mallet. The specific pitch of each bell 10 may be a function of a number of factors, including for instance the height of the bell, the maximum radius of the bell (the radius at the bottom edge of the bell, also referred to herein simply as the radius of the bell), the height of a thinned wall region, and/or the depth of the thinned wall region.

In particular, the spherical dome bells 10 may start off as hydroformed aluminum hemispheres, which may then be tuned. The tuning is done by “shortening” the bell (or reducing the height of the spherical dome, i.e. going from a hemisphere to a portion of a hemisphere), thinning the wall 11 of the bell in a region that extends a defined distance inward/upward from the bottom edge 13, or both.

Thinning of the inner wall of the bell results in a thinned wall portion 14 that is connected to the remainder of the inner wall, i.e. un-thinned portion 15, by a ledge 16 that is formed on the inner surface. FIGS. 8 and 9 show spherical dome bells 10 having a thinned wall portion 14 extending upward from the bottom edge 13 and separated from the remainder of the inner wall 15 by a ledge 16. The thinned wall portion 14 should extend evenly around the inner circumference of the wall. The thinned wall portion 14 can be prepared by a mechanical lathe or the like.

In some embodiments, one or more of the plurality of spherical domed bells 10 comprises a thinned inner wall region 14 extending upward a defined distance from a bottom edge 13 and wherein a depth of the thinned inner wall region, a height of the thinned inner wall region, or both are selected so that each bell produces a note on a musical scale when struck by a mallet. In some embodiments, a height of the thinned inner wall region 14 of each of these bells 10, shown in FIG. 9 as h1, may be between 5% and 60% of a total height of the bell, shown in FIG. 9 as h2. In some embodiments, a thickness of the thinned inner wall region 14 of each of these bells 10 may be between about 70% and about 95% of the thickness of an un-thinned inner wall region 15.

In some embodiments, one or more of the plurality of spherical dome bells 10 may have a height (h2) that is less than the radius defined by a bottom edge 13 of the bell. For instance, each of these bells 10 may have a height that is between about 60% and 99% of the radius defined by a bottom edge 13 of the bell.

Together, control over (i) the height (h2) of the bell 10 and/or (ii) the height (h1) and thickness of a thinned wall area 14 result in a spherical domed bell that is tuned to produce a defined note on a musical scale when the outer surface of the wall is struck with a mallet. Each tuned spherical dome bell 10 may be tuned to produce a note that is at least 85% accurate (as measured by a tuner), more preferably at least 90% accurate, more preferably at least 95% accurate, more preferably at least 98% accurate, more preferably at least 99% accurate. In some embodiments, a musical instrument 100 may include a plurality of tuned spherical dome bells 10, each of which is designed to produce a musical note within the same musical scale. An example of such a musical instrument 100 is shown in the embodiment illustrated in FIGS. 1-7.

Further, each bell may produce a note, when struck, that sustains for a prolonged time. It has presently been found for instance that embodiments of the spherical cap bells 10 described herein may have longer sustain times (and higher quality sound) than conical bells.

The bells 10 may also be anodized to provide a durable finish to withstand an outdoor environment, e.g. for use on a musical instrument 100 that is configured to be installed in an outdoor environment. This also allows for the provision of bells 10 having bright, playful colors, which may add to the visual appearance of the instrument 100.

It can be seen that the described embodiments provide unique and novel musical instruments 100, 200 and tuned spherical dome bells 10, each of which have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A musical instrument comprising:
a plurality of spherical dome bells; and
a frame that comprises
a support post having a top end and a bottom end, the bottom end being mounted to a ground surface;
a mounting bar attached to the top end of the support post;
the mounting bar comprising a plurality of fingers extending therefrom, each of the fingers supporting one of the plurality of tuned spherical dome bells.

2. The musical instrument of claim 1, wherein the mounting bar is linear or curvilinear and wherein the plurality of spherical dome bells are in a linear or curvilinear arrangement.

3. The musical instrument of claim 2, wherein the mounting bar is curvilinear and the plurality of spherical dome bells are in a curvilinear arrangement.

4. The musical instrument of claim 2, further comprising at least first and second mallets, each of the first and second mallets being connected to either the support post or the mounting bar by a flexible cable.

5. The musical instrument of claim 4, wherein the musical instrument further comprises first and second mallet holders configured to retain the first and second mallets.

6. The musical instrument of claim 5, wherein the first and second mallet holders are positioned on a plate that extends from the mounting bar and wherein the musical instrument further comprising a polymeric cushion element that is placed over at least a portion of the plate so as to surround the first and second mallet holders.

7. The musical instrument of claim 5, wherein the first and second mallet holders are positioned at a first end of the mounting bar.

8. The musical instrument of claim 7,
further comprising third and fourth mallets, each of the third and fourth mallets being connected to either the support post or the mounting bar by a flexible cable;
wherein the musical instrument further comprises third and fourth mallet holders configured to retain the third and fourth mallets, and
wherein the third and fourth mallet holders are positioned at a second end of the mounting bar.

9. The musical instrument of claim 1, wherein each of the plurality of spherical dome bells is spaced from the finger that supports it by a non-metal spacer.

10. The musical instrument of claim 9, wherein each finger extends upward from the mounting bar and each of the plurality of spherical dome bells is attached to the finger that supports it by a threaded fastener that passes through elements that comprise, in descending order, (i) an aperture at the center of the spherical dome bell, (ii) the non-metal spacer, and (iii) at least a portion of a central aperture of the finger.

11. The musical instrument of claim 1, wherein the bottom end of the support post is mounted to the outdoor surface by the base plate being attached to one of (a) an in-ground post, (b) an outdoor surface, or (c) an outdoor stand.

12. The musical instrument of claim 1, wherein each of the spherical domed bells is tuned to produce a note on a musical scale when struck with a mallet.

13. The musical instrument of claim 12, wherein one or more of the spherical domed bells comprises a thinned inner wall region extending upward a defined distance from a bottom edge, and wherein a depth of the thinned inner wall region, a height of the thinned inner wall region, or both are selected so that the bell produces a note on a musical scale when struck by a mallet.

14. The musical instrument of claim 12, wherein one or more of the spherical domed bells has a height that is less than the radius defined by a bottom edge of the bell.

15. The musical instrument of claim 14, wherein the height of the one or more bells is between about 60% and 99% of the radius defined by a bottom edge of the bell.

16. The musical instrument of claim 12, wherein each of the spherical dome bells produces a note that is at least 95% accurate.

17. The musical instrument of claim 12, wherein each of the spherical domed bells is made of aluminum or an aluminum alloy.

18. The musical instrument of claim 1, wherein the mounting bar extends substantially parallel with the ground surface and each of the fingers extends upward from the mounting bar.

19. The musical instrument of claim 1, wherein the mounting bar extends substantially parallel or at an acute angle with the ground surface and each of the fingers extends downward from the mounting bar.

20. The musical instrument of claim 19, the support post extends in a first direction and the mounting bar extends in a second, opposing direction.
